(19) United States
(12) Patent Application Publication
(10) Pub. No.: US 2005/0157324 A1
(43) Pub. Date: Jul. 21, 2005

(54) Multi function peripheral

(75) Inventor: Jinichi Miyazaki, Kyoto-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: MURATA KIKAI KABUSHIKI KAISHA, Kyoto-shi (JP)

(21) Appl. No.: 11/010,387

(22) Filed: Dec. 14, 2004

(30) Foreign Application Priority Data
Jan. 21, 2004 (JP) 2004-012914

(51) Int. Cl. G06F 3/12; G06F 15/00

(52) U.S. Cl. 358/1.13; 358/1.15

(57) ABSTRACT

In a MFP which supports the GDI as a standard, a PC print function by the PDL can be added as an option at low costs. The MFP includes a PC interface for receiving GDI print data from a PC and a function for executing a printing process in accordance with the received GDI print data. The MFP also includes a control unit. When a PDL option board is provided, in case of receiving data via the PC interface, the control unit determines whether the received data is GDI print data or PDL print data. When the received data is determined to be the PDL print data, the received data is processed by the PDL option board.

### BACKGROUND OF THE INVENTION

1. Field of the Invention

The present invention relates to a Multi Function Peripheral (MFP) having multiple functions such as a facsimile function and a copy function. In particular, the present invention relates to a MFP having an interface for carrying out communication with a Personal Computer (PC) and a PC print function for receiving printing data from the PC and carrying out a printing process.

2. Description of Related Art

A recent widespread MFP having a PC print function receives print data transmitted from a PC via an interface for carrying out communication with the PC, such as a Network Interface Card (NIC) and a parallel interface, and carries out a printing process.

To respond widely to various users, many of the commercially available MFPs support a facsimile function and a copy function as a standard. With respect to a PC print function, as shown in FIG. 4, a separately sold Page Description Language (PDL) option board 25 is added to a MFP 26 to support the PC print function.

The PDL option board 25 is always provided with a PC interface 3. The PDL option board 25 carries out processing such as rasterizing of PDL print data received via the PC interface 3 provided on the PDL option board 25. Therefore, the costs of the PDL option board 25 become expensive by including a PDL print data processing unit and also the PC interface 3.

Meanwhile, a Graphics Device Interface (GDI), which is another print data format, also requires the PC interface 3. However, since the processing such as the rasterizing of the data is carried out by the PC 2, a load on a control source of the MFP 26 is small. As a result, even when the control source of the MFP 26 is used for the processing of the GDI print data, there is no problem. Accordingly, even when the MFP 26 supports the GDI print method as a standard, most of the costs for embedding the processing of the GDI print data are the costs of the PC interface 3. Therefore, compared with the case in which the PDL option board 25 is provided, the PC interface 3 can be adopted at considerably low costs.

If both the PDL method and the GDI method can be used, advantages of each of the methods can be used differently and utilized effectively. For example, when a user wishes to print out an original document created by a word-processing program of the PC 2 directly by a font format displayed on a monitor of the PC 2, the GDI method can be selected. When the user wishes to print out a picture image or the like edited by the PC 2 as beautiful as possible, in general, the picture image or the like can be printed out more beautifully if the PDL method is selected. A known MFP receives GDI print data from a PC connected to the MFP and carries out a PC printing process.

However, when the PC print functions of both of the methods are added as an option to the MFP 26, or when a PDL PC print function is added as an option to the MFP 26 which supports the GDI as a standard, two PC interfaces 3 are provided in the MFP 26. As a result, the costs of the option increase. In addition, an expensive device such as a Universal Serial Bus (USB) is recently adopted for the PC interface 3. In case such an expensive PC interface is adopted, the costs of the option increase even more.

### BRIEF SUMMARY OF THE INVENTION

The present invention has been made in consideration of the above-described circumstances. An advantage of the present invention is to provide a MFP which supports a GDI as a standard, in which a PDL PC print function can be added as an option at low costs.

According to an aspect of the present invention, the MFP includes a PC interface for receiving rasterized print data from a PC. The MFP includes a function for executing a printing process in accordance with the received print data. The MFP also includes a control unit. When an option board for processing print data of a vector data format is provided, in case of receiving data via the PC interface, the control unit determines whether the received data is the rasterized print data or the print data of the vector data format. When the received data is determined to be the print data of the vector data format, the received data is processed by the option board.

According to an aspect of the present invention, the PC interface is a parallel interface, a NIC or a USB.

According to an aspect of the present invention, the rasterized print data is GDI print data, and the print data of the vector data format is a PDL.

According to the present invention, the PC interface which is required to be provided on a conventional option board for processing the print data of the vector data format (for example, the PDL) can be omitted. As a result, the PC print function for printing the print data of the vector data format (for example, the PDL) can be added at considerably low costs to the MFP which supports the GDI PC print function or the like as a standard.

According to the present invention, one of the parallel interfaces, the NIC or the USB can be omitted. As a result, compared with a conventional machine, the costs can be reduced. In particular, in case the PC interface is the NIC or the USB interface, (including a USB host controller) which are expensive interfaces, the costs can be reduced considerably.

### BRIEF DESCRIPTION OF THE SEVERAL VIEWS OF THE DRAWING

FIG. 1 shows the case in which a PDL option board not having a PC interface is added to a MFP according to an embodiment of the present invention.

FIG. 2 is a block diagram showing an example of a configuration of the MFP according to an embodiment of the present invention.

FIG. 3 is a flowchart showing a processing operation carried out when the MFP receives print data according to an embodiment of the present invention.

FIG. 4 shows a case in which a PDL option board with a PC interface is added to a conventional MFP.

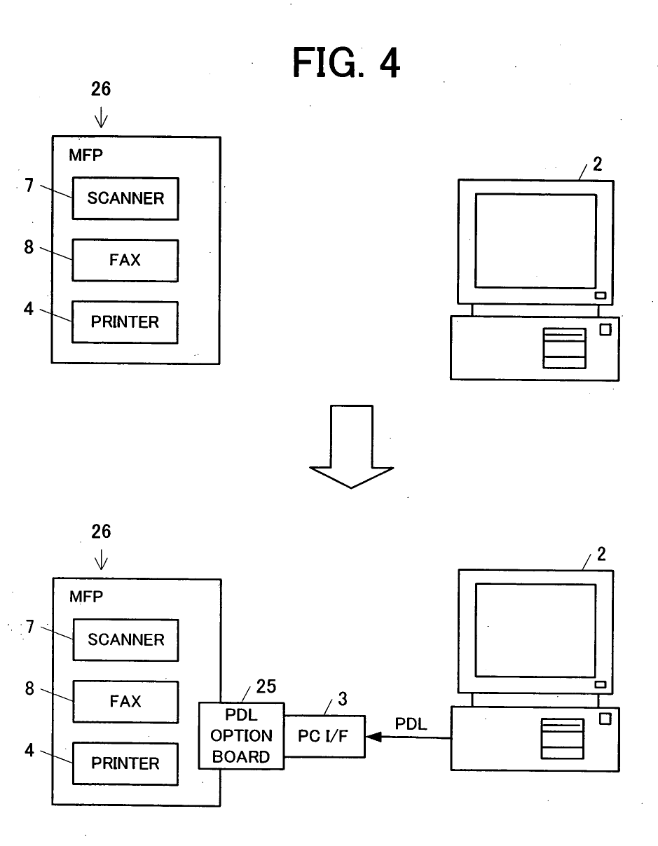

### DETAILED DESCRIPTION OF THE INVENTION

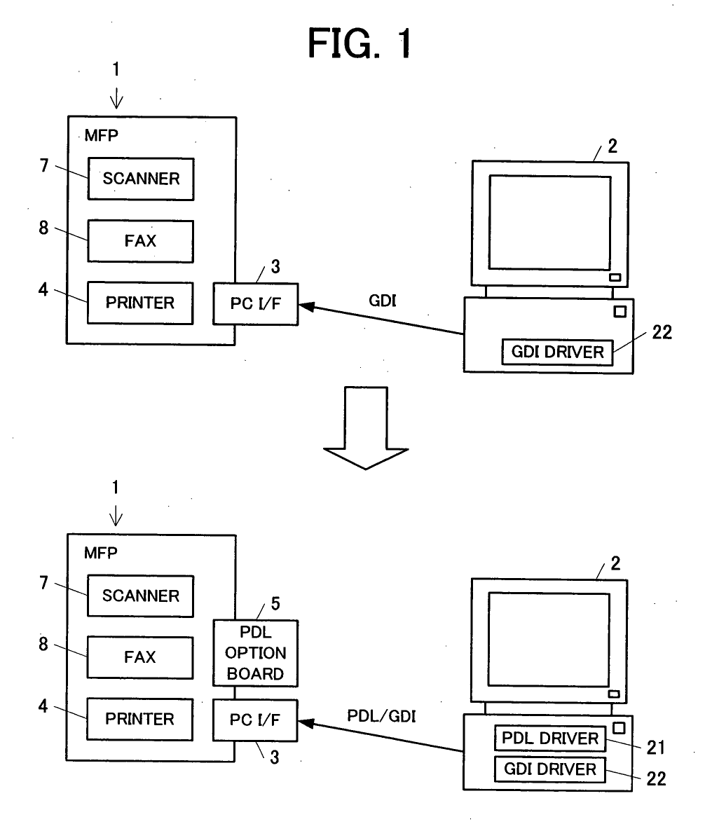

Embodiments of the present invention will be described with reference to the drawings. As shown in the functional block diagram of FIG. 1, a MFP 1 according to the present embodiment includes at least an interface 3 for a PC 2 (hereinafter referred to as the “PC interface 3”), a GDI printer function 4, and a socket and a circuit for inserting a PDL option board 5. As shown in the lower half of FIG. 1, when the PDL option board 5 is inserted and the MFP 1 receives data via the PC interface 3, a control unit (not shown) determines whether the received data is PDL print data or GDI print data. When the control unit determines that the received data is the PDL print data, the PDL option board 5 carries out a processing such as rasterizing of the received data. When the received data is the GDI print data, the control unit carries out a prescribed processing on the received data. The MFP 1 of the present embodiment further includes a scanner function 7 and a facsimile function 8. The type of the functions and the number of types of the functions of the MFP 1 are not limited to the example of the present embodiment. The GDI print data is an example of the print data rasterized by the PC 2 and received by the MFP 1. The PDL print data is an example of the print data of the vector data format received by the MFP 1 without being rasterized by the PC 2. The types of the print data are not limited to the GDI and the PDL of the above-mentioned specific examples.

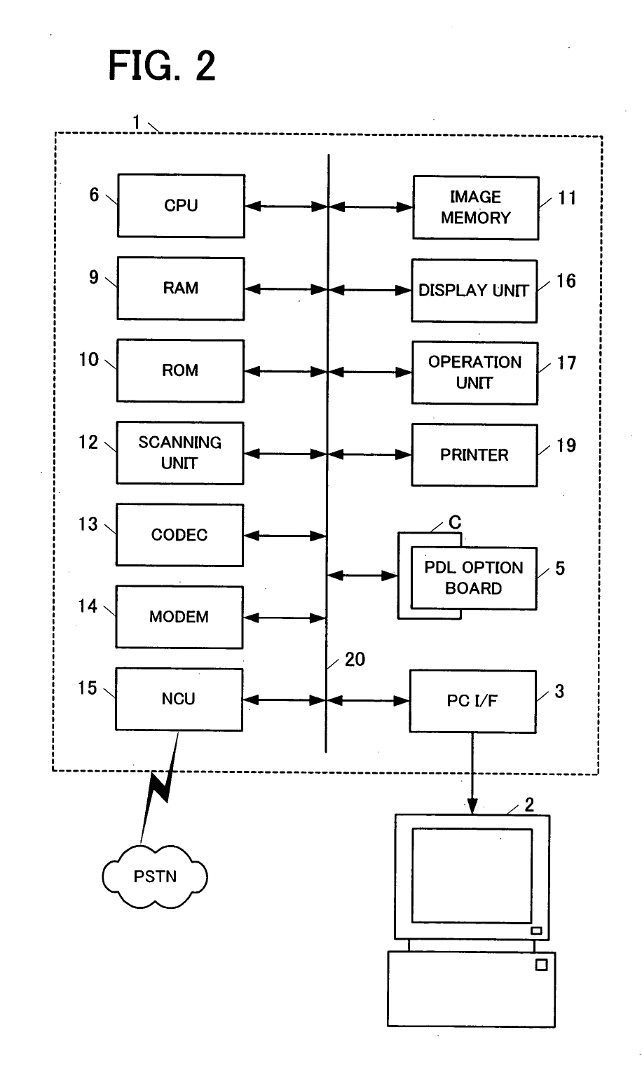

FIG. 2 is a block diagram showing an example of a configuration of the MFP 1. That is, the MFP 1 includes a Central Processing Unit (CPU) 6, a Random Access Memory (RAM) 9, a Read Only Memory (ROM) 10, an image memory 11, a scanning unit 12, a codec 13, a modem 14, a Network Control unit (NCU) 15, a display unit 16, an operation unit 17 and a printer 19. The MFP 1 also includes a PDL option board 5 connected detachably to a bus 20 via a connector C, and a PC interface 3. Each of the units 5, 6 and 9 through 19 are connected by the bus 20.

The CPU 6 functions as a control unit which controls each of the units of the MFU 1 in accordance with a control program stored in the ROM 10. The RAM 3 functions as a main memory and a working area or the like of the CPU 6. The ROM 10 stores the control program. The image memory 11 temporarily stores and accumulates image data scanned by the scanning unit 12 and image data compressed and encoded by the codec 13.

The scanning unit 12 includes a Charge Coupled Device (CCD) line sensor, an Analog-to-Digital (A/D) converter and an image processing circuit or the like. The scanning unit 12 scans image data of an original document. The codec 13 compresses and encodes the image data stored in the image memory 11 or decodes received encoded data in accordance with a Modified Huffman (MH), a Modified Read (MR) and a Modified Modified Read (MMR) methods or the like.

The display unit 16 is a Liquid Crystal Display (LCD) or the like provided on the operation unit 17. The display unit 16 functions to display various pieces of screen information. The operation unit 17 includes input keys or the like for inputting information such as characters. A user carries out various operations from the operation unit 17. The printer 19 forms an image onto recording paper in accordance with the received GDI print data or the print data rasterized by the PDL option board 5.

For example, in accordance with a command from the CPU (control unit) 6, the PDL option board 5 analyzes the PDL print data received via the PC interface 3 and rasterizes the analyzed print data. Then, the PDL option board 5 outputs the image data to the printer 19.

The PC interface 3 receives the GDI print data or the PDL print data from the PC 2. An interface for carrying out communication with the PC 2, such as a NIC, a parallel interface and a USB, is adopted for the PC interface 3. Further, in case the PC interface 3 is the USB, a USB connector and a USB host controller (not shown) are provided.

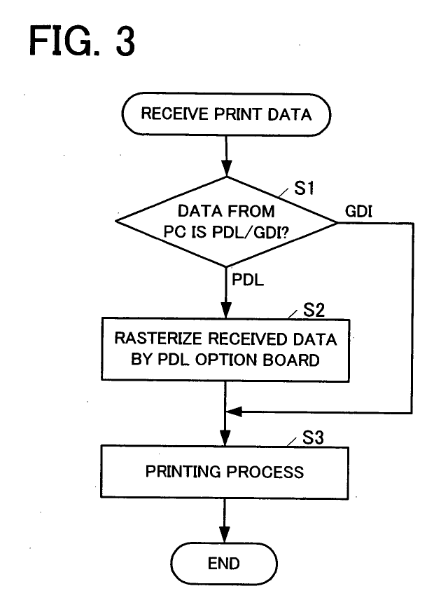

Next, referring to the flowchart of FIG. 3, a description will be made of a processing operation carried out by the MFP 1 when a printing operation is carried out at the PC 2 connected to the MFP 1 via the PC interface 3. Further, the processing operation of the MFP 1 to be described with reference to FIG. 3 is carried out by following the command generated by the CPU (control unit) 6 in accordance with the control program stored in the ROM 10. The rasterizing process or the like of the PDL print data is carried out in the PDL option board 5.

The PC 2 includes a printer driver 21 for carrying out a printing process by the PDL and a printer driver 22 for carrying out a printing process by the GDI (refer to the lower half of FIG. 1). When one of the printer drivers 21 and 22 is selected by the user of the PC 2 and a prescribed operation is carried out for starting the printing process, the PDL print data or the GDI print data of the original document created by application software is generated. Then, the generated print data is transmitted to the MFP 1. The MFP 1 receives the print data transmitted via the PC interface 3. Then, a determination is made as to whether the received print data is the PDL print data or the GDI print data (step S1). When a determination is made that the received print data is the PDL print data, the received data is transmitted to the PDL option board 5. The PDL option board 5 analyzes the PDL print data and carries out a processing such as rasterizing of the print data (step S2). The rasterized image data is transmitted to the printer 19. The printer 19 carries out an image forming process onto recording paper (step S3).

Meanwhile, at step S1, when a determination is made that the received print data is the GDI print data, the CPU 6 carries out necessary data processing. Then, the print data is transmitted to the printer 19. The printer 19 carries out an image forming process onto recording paper (step S3).

The above-described processing operation is carried out when the PDL option board 5 is provided in the MFP 1. When the PDL option board 5 is not provided, in case of receiving the PDL print data, the CPU 6 carries out a prescribed error processing to notify an error. For example, the CPU 6 displays a message, “noncompliant print data has been received”, on the display unit 16.

As described above, according to the MFP 1 of the present embodiment, when the PDL option board 5 is provided, in case of receiving the PDL print data via the PC interface 3, the CPU 6 executes a processing such as rasterizing of the print data by using the PDL option board 5. Therefore, the PDL option board 5 is not necessary to be provided with the PC interface as in a conventional machine. As a result, the costs can be reduced. When printing out the original document created by the application software of the PC 2 directly by the font format displayed on the monitor of the PC 2, the GDI is selected. When printing out the picture image or the like edited by the PC 2 as beautiful as possible, the PDL is selected. Accordingly, convenience of the user improves considerably.

The present invention can be applied to, for example, an MFP which includes a PC interface and includes a PC print function for receiving print data of an original document from a PC and carrying out a printing process.

1. A multi function peripheral, comprising:
a personal computer (PC) interface which receives rasterized print data from a PC;
a function for executing a printing process in accordance with received print data; and
a control unit, wherein when the multi function peripheral includes an option board which processes print data of a vector data format, in case of receiving data via the PC interface, the control unit determines whether the received data is the rasterized print data or the print data of the vector data format, and in case the control unit determines the received data to be the print data of the vector data format, the received data is processed by the option board.

2. The multi function peripheral according to claim 1, wherein the PC interface is a parallel interface.

3. The multi function peripheral according to claim 1, wherein the PC interface is a Network Interface Card (NIC).

4. The multi function peripheral according to claim 1, wherein the PC interface is a Universal Serial Bus (USB).

5. The multi function peripheral according to claim 1, wherein the rasterized print data is Graphics Device Interface (GDI) print data.

6. The multi function peripheral according to claim 1, wherein the print data of the vector data format is a Page Description Language (PDL).

7. A method for carrying out a printing process in accordance with received print data in a multifunction peripheral having a Personal Computer (PC) interface for receiving rasterized print data from a PC, the method comprising the steps of:
determining whether or not the multi function peripheral includes an option board for processing print data of a vector data format;
determining whether data received via the PC interface is the rasterized print data or the print data of the vector data format in case the multi function peripheral includes the option board for processing the print data of the vector data format; and
processing the received data by the option board when the received data is determined to be the print data of the vector data format.

8. The method for carrying out the printing process according to claim 7, wherein the PC interface is a parallel interface.

9. The method for carrying out the printing process according to claim 7, wherein the PC interface is a Network Interface Card (NIC).

10. The method for carrying out the printing process according to claim 7, wherein the PC interface is a Universal Serial Bus (USB).

11. The method for carrying out the printing process according to claim 7, wherein the rasterized print data is Graphics Device Interface (GDI) print data.

12. The method for carrying out the printing process according to claim 7, wherein the print data of the vector data format is a Page Description Language (PDL).
